(19) United States
(12) Patent Application Publication
(10) Pub. No.: US 2020/0109818 A1
(43) Pub. Date: Apr. 9, 2020

(54) LOW PUNCTURE FORCE GAS CANISTER

(71) Applicant: Nuance Designs of CT, LLC, Woodbridge, CT (US)

(72) Inventors: Carlos Guillermo, Atascadero, CA (US); David DeSalvo, Lake Hiawatha, NJ (US)

(73) Assignee: Nuance Designs of CT, LLC, Woodbridge, CT (US)

(21) Appl. No.: 16/155,055

(22) Filed: Oct. 9, 2018

(51) Int. Cl. F17C 13/06

(52) U.S. Cl. CPC F17C 13/06; F17C 2205/032; F17C 2201/058; F17C 2201/0104

(57) ABSTRACT

A system for delivering a flow of pressurized gas including a canister for receiving a pressurized gas, the canister including a lateral wall defining an internal cavity, an open top end formed by the lateral wall and in fluid communication with the internal cavity, and a pierceable wall integrally formed with the lateral wall distal to the open top end, wherein the pierceable wall is a low puncture force pierceable wall. The system further includes a piercing member movable between a first position spaced from the canister and a second position piercing the pierceable wall of the canister.

The present disclosure relates generally to a pressurized gas delivery device. Specifically, the present disclosure relates to a pressurized gas canister having a low puncture force pierceable wall.

### BACKGROUND OF THE INVENTION

A gas canister is designed to store pressurized gas which can be released to provide a projection force outwardly away from the canister. Conventional gas canisters are relatively large and require a mechanical means to release the gas contained therein, e.g., by a valve, or by piercing the canister. Typical piercing means can be quite complex or require sufficiently high force to pierce the canister.

### BRIEF SUMMARY

In accordance with an exemplary embodiment, the present disclosure provides a canister for receiving a pressurized gas comprising a lateral wall defining an internal cavity, an open top end formed by the lateral wall and in fluid communication with the internal cavity. The canister further comprises a pierceable wall formed with the lateral wall distal to the open top end, wherein the pierceable wall is a low puncture force pierceable wall.

An aspect of the present disclosure is that the low puncture force pierceable wall is pierceable by a low puncture force less than 10 lb_{f}, by a low puncture force less than 2 lb_{f}, or by a low puncture force less than 1 lb_{f}. An aspect of the present disclosure is that the pierceable wall is configured to be pierceable due to shear failure, or the low puncture force pierceable wall is pierceable by a low puncture force less than 2 lb_{f} due to shear failure. An aspect of the present disclosure is that the pierceable wall has a wall thickness less than about 0.40 mm, less than about 0.30 mm, less than about 0.20 mm, or less than about 0.10 mm. An aspect of the present disclosure is that the pierceable wall has a shear strength suitable to be pierceable by a puncture force less than 10 lb_{f}, or suitable to be pierceable by an awl tool with a puncture force less than 10 lb_{f}. The pierceable wall has a shear strength suitable to be pierceable by a puncture force less than 2 lb_{f}, or suitable to be pierceable by an awl tool with a puncture force less than 2 lb_{f}. An aspect of the present disclosure is that the pierceable wall is sized and configured to withstand a load no greater than 10 lb_{f}, or to withstand a load no greater than 2 lb_{f}. An aspect of the present disclosure is that the pierceable wall is sized and configured to store pressures no greater than about 1300 psi, or sized and configured to store pressures no greater than about 900 psi. An aspect of the present disclosure is that the pierceable wall extends substantially transverse to the lateral wall. An aspect of the present disclosure is that the canister includes a sealing member hermetically sealing the open top end. The lateral wall is substantially cylindrical in shape or includes a main body portion and a nose portion having an overall width less than the main body portion. An aspect of the present disclosure is that the pierceable wall may be integrally formed with the nose portion. In an embodiment, the nose portion may have an overall width less than about 3 mm, the lateral wall may have an overall longitudinal length of less than about 20 mm and an overall width of less than about 10 mm. The internal cavity of the canister may have a volume of about 0.125 cm³ to about 1.25 cm³. An aspect of the present disclosure is that the pierceable wall comprises at least one of aluminum, steel, tin, gold, silver, and nickel.

In accordance with an exemplary embodiment, the present disclosure provides a system for delivering a flow of pressurized gas comprising a canister for receiving a pressurized gas comprising a lateral wall defining an internal cavity, an open top end formed by the lateral wall and in fluid communication with the internal cavity. The canister further comprises a pierceable wall formed with the lateral wall distal to the open top end, wherein the pierceable wall is a low puncture force pierceable wall. The system further comprises a piercing member movable between a first position spaced from the canister and a second position piercing the pierceable wall of the canister.

An aspect of the present disclosure is that the piercing member includes a piercing device comprising a pointed stake. The pointed stake can have a tip angle of about 30-60 degrees. The piercing device may have a diameter of about 0.75 mm. The piercing device may be in the form of an annular needle, an annular stake, or an annular wedge having an aperture extending therethrough. In the alternative, the piercing member may be configured as a flat spike so long as it is capable of rupturing the pierceable wall. An aspect of the present disclosure is that the piercing member is sized and configured to pierce the pierceable wall upon engagement thereto and application of a low puncture force less than 10 lb_{f}. The piercing member comprises a piercing device having a hardness greater than a hardness of the pierceable wall. The pierceable wall comprises a Rockwell Hardness of 20B-60B and the piercing device comprises a Rockwell Hardness of 65B-100B. An aspect of the present disclosure is that the system for delivering a flow of pressurized gas further comprises an actuator to urge the piercing member from the first position to the second position. The actuator comprises a biasing member, a pressurized gas, or a mechanical cylinder.

In accordance with an exemplary embodiment, the present disclosure provides a method of manufacturing a pressurized gas canister comprising forming a canister having a lateral wall defining an internal cavity, an open top end formed by the lateral wall and in fluid communication with the internal cavity, and a pierceable wall formed with the lateral wall distal to the open top end, wherein the pierceable wall is a low puncture force pierceable wall, as a unitary part. The method further comprises filling the canister with a gas at a pressure of at least 15 psi through the open top end, and hermetically sealing the canister with a sealing member after filling the canister. The step of forming the canister as a unitary part comprises machining, cold forming, drawing, punching or any other appropriate metal forming process.

In accordance with an exemplary embodiment, the present disclosure provides a pressurized gas canister comprising a lateral wall defining an internal cavity and an open top end formed by the lateral wall and in fluid communication with the internal cavity. The pressurized gas canister further comprises a low puncture force pierceable wall hermetically sealed with the lateral wall distal to the open top end, wherein the low puncture force pierceable wall is pierceable by a low puncture force less than 10 lb_{f}. The pressurized gas canister further comprises a gas within the internal cavity at a pressure of at least 15 psi, and a sealing member hermetically sealing the open top end by press-fit and/or mechanical engagement.

### BRIEF DESCRIPTION OF THE SEVERAL VIEWS OF THE DRAWINGS

The foregoing summary, as well as the following detailed description of the exemplary embodiments of the disclosure, will be better understood when read in conjunction with the appended drawings. For the purpose of illustrating the invention, there are shown in the drawings exemplary embodiments of the disclosure. It should be understood, however, that the invention is not limited to the precise arrangements and instrumentalities shown.

In the drawings:

FIG. 1 is a perspective view of a system for delivering a flow of pressurized gas in accordance with an exemplary embodiment of the present disclosure;

FIG. 2 is another perspective view of the system of FIG. 1;

FIG. 3 is an exploded perspective view of the system of FIG. 1;

FIG. 4A is a partially exploded side view of the system of FIG. 1;

FIG. 4B is a side cross-sectional view of the system of FIG. 4A;

FIG. 4C is an exploded side cross-sectional view of the system of FIG. 4A;

FIG. 5A is a perspective view of a piercing member in accordance with an exemplary embodiment of the present disclosure;

FIG. 5B is a perspective cross-sectional view of the piercing member of FIG. 5A;

FIG. 5C is a perspective view of a piercing member in accordance with a further exemplary embodiment of the present disclosure;

FIG. 6 is a partial side view of a canister and pierceable wall in accordance with an exemplary embodiment of the present disclosure;

FIG. 7 is an enlarged cross-sectional view a pierceable wall in accordance with an exemplary embodiment of the present disclosure; and

FIG. 8 is a partial cross-sectional view of a system for delivering a flow of pressurized gas in accordance with an exemplary embodiment of the present disclosure.

### DETAILED DESCRIPTION

Reference will now be made in detail to the various exemplary embodiments illustrated in the accompanying drawings. Wherever possible, the same or like reference numbers will be used throughout the drawings to refer to the same or like features. It should be noted that the drawings are in simplified form and are not drawn to precise scale. Certain terminology is used in the following description for convenience only and is not limiting. Directional terms such as top, bottom, left, right, above, below, and diagonal are used with respect to the accompanying drawings. The term “distal” shall mean away from the center of a body. The term “proximal” shall mean closer towards the center of a body and/or away from the “distal” end. The words “inwardly” and “outwardly” refer to directions toward and away from, respectively, the geometric center of the identified element and designated parts thereof. Such directional terms used in conjunction with the following description of the drawings should not be construed to limit the scope of the subject disclosure in any manner not explicitly set forth. Additionally, the term “a,” as used in the specification, means “at least one.” The terminology includes the words above specifically mentioned, derivatives thereof, and words of similar import.

“About,” as used herein, when referring to a measurable value such as an amount, a temporal duration, and the like, is meant to encompass variations of ±20%, ±10%, ±5%, ±1%, or ±0.1% from the specified value, as such variations are appropriate.

“Substantially,” as used herein, shall mean considerable in extent, largely, but not wholly, that which is specified, or an appropriate variation therefrom as is acceptable within the field of art.

“Pierceable wall,” as used herein shall mean a wall which is penetrable by a piercing tool upon application of a modest force. A modest force is, e.g., the piercing tool traveling at less than 1 ft/s or, e.g., less than about 50N_{f}. “Pierceable,” as used herein, does not encompass breaking or penetrating by means incorporating e.g., a high force, or high energy projectile or member, e.g., a projectile such as a bullet or the like.

Throughout this disclosure, various aspects of the exemplary embodiments can be presented in a range format. It should be understood that the description in range format is merely for convenience and brevity and should not be construed as an inflexible limitation on the scope of the subject disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages, and characteristics of the exemplary embodiments may be combined in any suitable manner in one or more embodiments. One skilled in the relevant art will recognize, in light of the description herein, that the exemplary embodiments can be practiced without one or more of the specific features or advantages of a particular exemplary embodiment. In other instances, additional features and advantages may be recognized in certain embodiments that may not be present in all exemplary embodiments.

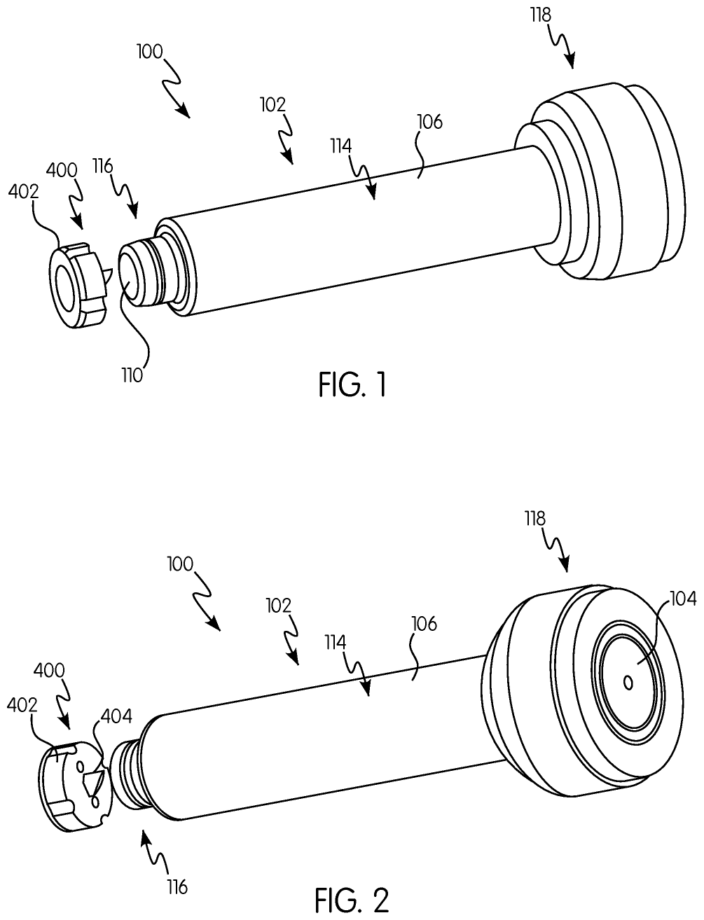

Referring now to the drawings, FIGS. 1 through 8 illustrate exemplary embodiments of the present disclosure of a system 100 for delivering a flow of pressurized gas. The system 100 is configured substantially as shown and includes a canister 102, a sealing member 104, pressurized gas 300 and a piercing member 400.

Referring now to FIGS. 1 through 4C, the canister 102 is configured substantially as shown. In an exemplary embodiment, the canister 102 comprises a lateral wall 106 an open top end 108 and a pierceable wall 110. The lateral wall defines an internal cavity 112 for containing the pressurized gas 300 therein. The lateral wall 106 comprises a main body portion 114 that is substantially cylindrical in shape. The lateral wall 106 further includes a reduced diameter portion or nose portion 116 that is substantially cylindrical or cylindrical in shape, about a distal end, and an increased diameter portion 118 about its proximal end.

The reduced diameter portion or nose portion 116 includes the pierceable wall 110 and has an overall width less than a width of the body portion 114. The nose portion has an overall width of less than about 3 mm, but can alternatively be more or less e.g., 4 mm, 5 mm, 2 mm, or 1 mm. The nose portion also has a length less than a longitudinal length of the main body portion. For example, the longitudinal length of the nose portion is about less than ⅓, ¼, ⅕, or ⅙ a longitudinal length of the main body portion.

The pierceable wall 110 extends substantially transverse to the lateral wall 106 and is integrally formed with the nose portion 116 to define a portion of the internal cavity 112 for housing the pressurized gas 300 therein. The pierceable wall is at a distal end of the canister, or distal to the open top end. The pierceable wall is preferably integrally formed, e.g., by being drawn, formed, punched or machined.

The increased diameter portion 118 includes the open top end 108 which includes a connecting portion 120, such as flanges as or threads for operatively engaging the sealing member 104. Alternatively, the connecting portion 120 may be provided on the sealing member 104. The open top end is in fluid communication with the internal cavity 112. The sealing member 104 is operable to hermetically seal the open top end 108.

In other words, the canister 102 comprises a housing that is substantially cylindrical or cylindrical. The lateral wall 106 forms the main body portion 114 of the housing, and the pierceable wall 110 has a width less than a width of the main body portion. Furthermore, the lateral wall 106 includes a reduced diameter portion or nose portion 116 having the pierceable wall integrally formed with the reduced diameter portion. Also, the main body portion is substantially cylindrical or cylindrical and the reduced diameter portion is substantially cylindrical or cylindrical.

In an exemplary embodiment, an internal volume of the cavity 112 is about 0.125 cm³. It is appreciated that the internal volume can vary, e.g., to be 0.150, 0.175, 0.200, 0.115, 0.100 or 0.090 cm³. In an exemplary embodiment, to have an internal volume of about 0.125 cm³, the main body portion 114 may have an overall longitudinal length less than about 20 mm and an overall width less than about 10 mm, and the reduced diameter or nose portion may have an overall width of less than about 3 mm. It is appreciated that the body width dimensions described above can vary to achieve the desired internal volume, e.g., the housing may have larger or smaller dimensions to accommodate increasingly larger or smaller amounts of pressurized gas. For instance, the housing may be suitably dimensioned to have an internal volume of 1.25 cm³±10%, 15%, 20%, or 25%.

In an exemplary embodiment, the pierceable wall 110 is positioned distal and opposite the open top end 108. The pierceable wall further has a thickness configured to store pressurized gas 300 at a pressure of at least 15 psi, to no greater than about 1300 psi, e.g., 100, 200, 300, 400, 500, 600, 700, 800, 900, 1000, 1100, or 1200 psi. The pierceable wall may be formed of a metal, such as, aluminum, steel, tin, gold, silver, nickel, or a combination thereof. Further, in an exemplary embodiment, the pierceable wall has a wall thickness less than a wall thickness of the lateral wall 106. In an exemplary embodiment, the pierceable wall has a wall thickness less than about 0.40 mm, less than about 0.30 mm, less than about 0.20 mm, or less than about 0.10 mm.

In addition, it is contemplated that the pierceable wall may be thicker around its perimeter and thinner near the center where it is punctured. For example, as shown in FIG. 7, the pierceable wall 110″, may have a relatively thinner center region 110″ a where it is punctured and a relatively thicker perimeter region 110″b where it is secured to the canister.

The low puncture force pierceable wall 110 is pierceable by a low puncture force less than 10, 9, 8, 7, 6, 5, 4, 3, 2 or 1 lb_{f}. The pierceable wall is configured to be pierceable due to shear failure. The low puncture force pierceable wall is pierceable by a low puncture force less than 2 lb_{f} due to shear failure. The pierceable wall has a shear strength suitable to be pierceable by a puncture force less than 10 lb_{f}. The pierceable wall has a shear strength suitable to be pierceable by an awl tool with a puncture force less than 10 lb_{f}. The pierceable wall further has a shear strength suitable to be pierceable by a puncture force less than 2 lb_{f}. The pierceable wall is suitable to be pierceable by an awl tool with a puncture force less than 2 lb_{f}. The pierceable wall is sized and configured to withstand a load no greater than 10, 9, 8, 7, 6, 5, 4, 3, 2, or 1 lb_{f}.

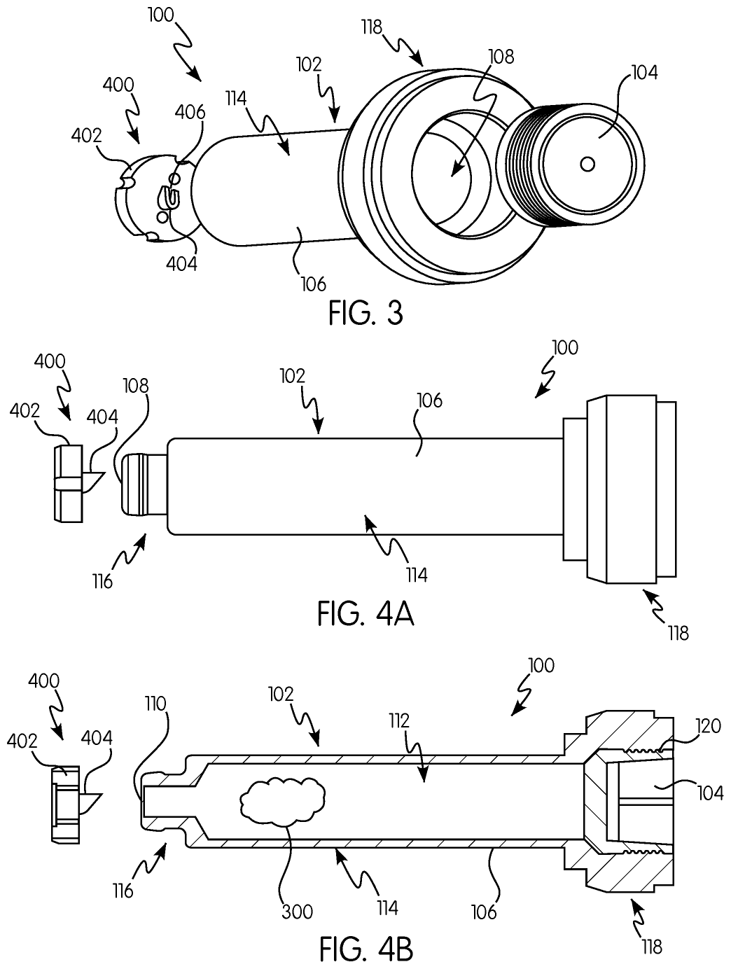

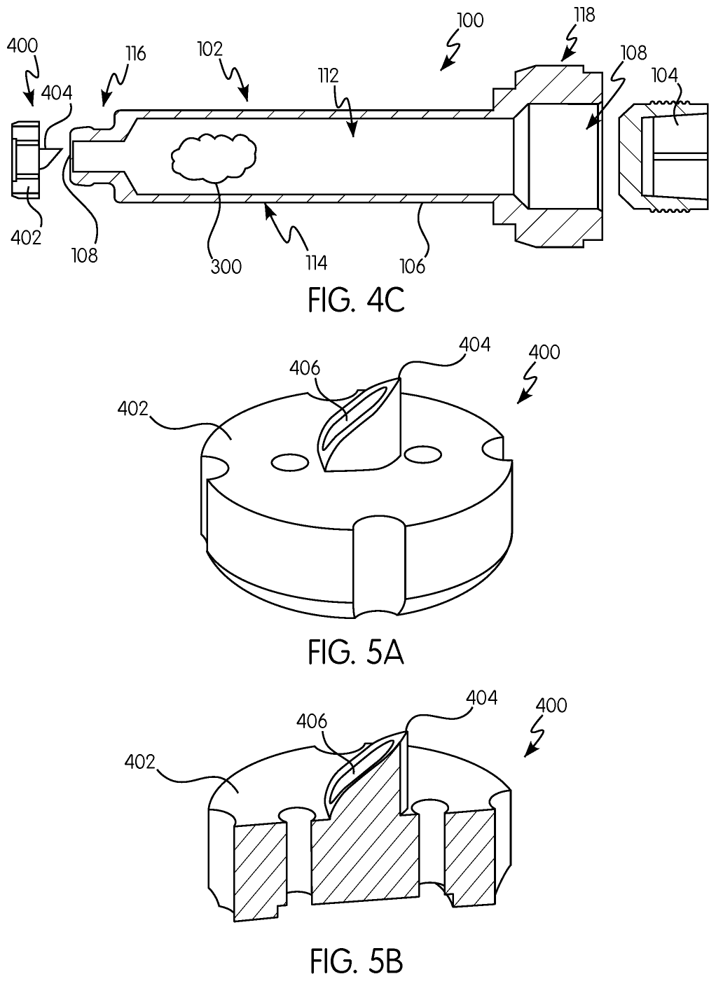

Referring to FIGS. 3 and 4C, the sealing member 104 may be configured substantially as shown. The sealing member 104 may be sized and shaped to sealingly fit and engage the increased diameter portion 118 for hermetically sealing the open top end 108 and the cavity 112 of the canister 102. In an exemplary embodiment, the sealing member is a hydraulic plug. The sealing member may be formed from any suitable materials, such as, metal, a polymer, e.g., elastomer or plastic, and preferably hermetically seals the open top end 108 and the internal cavity 112. The sealing member may further be configured with peripheral serrations or ribs 120 for securing the sealing member to the increased diameter portion. The sealing member may seal the open top end 108 by press-fit and/or mechanical engagement. As shown in FIG. 8, the sealing member may alternatively be an appropriately sized smooth metal or plastic ball bearing 104′.

Alternatively, the top end of the canister 202 may be formed as a solid closed end, i.e., without an opening and sealing member. So constructed, the canister may be filled with liquefied or compressed gas that is introduced at an open distal or bottom end of the canister. As shown in FIG. 6, the open bottom end would then be covered over with a pierceable wall 210 that is crimped or otherwise sealingly secured, e.g., by welding or adhered with a bonding agent or adhesive, to the reduced diameter portion 216. The pierceable wall 210 is capable of maintaining high gas pressure within the canister yet is pierceable by a low puncture force.

Referring now to FIGS. 4B and 4C, in an exemplary embodiment, the pressurized gas 300 acts as a pressure source that can be used to apply a force, when released, to an external component, such as a syringe or drive mechanism. The pressurized gas can be, e.g., n-butane, nitrous oxide (N₂O), or carbon dioxide (CO₂). Alternatively, the canister can be filled with a liquefied gas such as any suitable propellant or refrigerant. Exemplary liquefied gases applicable to the present disclosure include but are not limited to hydrocarbon propellants (e.g., butane, isobutane, and propane). A liquefied gas provides a pressure equal to its vapor pressure. Thus, upon piercing of the canister the output pressure would be the vapor pressure of the liquefied gas.

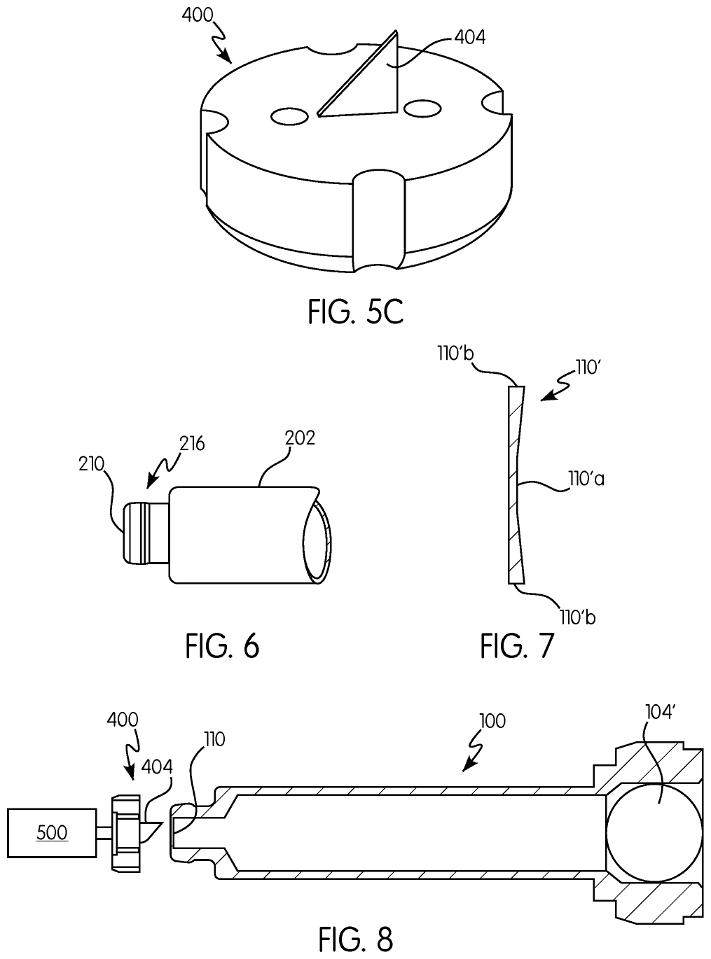

Referring now to FIGS. 5A and 5B, in an exemplary embodiment, the piercing member 400 is configured substantially as shown. The piercing member 400, along with the above-described canister 102, are constituents of the system for delivering a flow of pressurized gas. The piercing member 400 includes a body 402 and a piercing device 404 extending from the body.

The piercing device 404 can be, for example, an annular cannula, an annular pointed stake, an annular needle, an annular stake, an annular wedge, or the like, having an aperture 406 extending therethrough which is sufficient to pierce the pierceable wall 110 of the canister 102. The piercing device 404 facilitates fluid communication of the pressurized gas from housing when the piercing member is in the second position. The piercing device may have a tapered tip angle of about 30-60 degrees or alternatively 20, 25, 65, or 70 degrees, including 35, 40, 45, 50, and 55 degrees, a height of about 2 mm or alternatively 2.5, 3.0 or 1.5 mm, and a diameter of about 0.75 mm or alternatively 0.8 or 0.7 mm.

The piercing member is sized and configured to pierce the pierceable wall upon engagement therewith and application of a low puncture force less than 10 lb_{f}. In the alternative, as shown in FIG. 5C, the piercing member may be configured as a flat spike 404′ so long as it is capable of rupturing the pierceable wall.

In sum, the piercing member 400 is configured to move between a first position and a second position relative to the canister 102. In the first position, the piercing device 404 is spaced from the pierceable wall, and in the second position the piercing member pierces the pierceable wall with the piercing member.

In an exemplary embodiment, the piercing device 404 has a hardness greater than a hardness of the pierceable wall. For example, the piercing device 404 can be formed of a metal having a Rockwell Hardness of about B65-B100, whereas the pierceable wall 108 can be formed of metal having a Rockwell Hardness of about B20-B60.

It is generally understood that ductile materials fail in shear, whereas more rigid materials fail in tension. That is, ductile materials such as those used to form the pierceable wall 110 are more susceptible to puncturing, which is a form of shearing. In contrast, more rigid materials such as those used to form the piercing device 404 fail in tension which involves a higher degree of force than the shear force necessary to pierce the pierceable wall.

As shown in FIG. 8, the system for delivering a flow of pressurized gas according to the subject disclosure can further comprise an actuator 500 to urge the piercing member 400 from the first position to the second position. Such actuator may comprise a biasing member, a pressurized gas, a mechanical actuator or a mechanical cylinder. In an embodiment, the piercing member may be driven by a spring or other biasing member which generates the necessary piercing force.

In an exemplary embodiment, the subject disclosure contemplates a method of manufacturing a pressurized gas canister. The method comprises forming the aforementioned canister 102 as a unitary part by machining or cold-forming. Thereafter, the canister is filled with a gas at a pressure of at least 15 psi through the open top end 150 and the canister is hermetically sealed with the sealing member 104.

It will be appreciated by those skilled in the art that changes could be made to the preferred embodiments described above without departing from the broad inventive concept thereof. For example, additional components, types of piercing devices, or different materials can be used with the low puncture force canister. It is to be understood, therefore, that this invention is not limited to the particular embodiments disclosed, but it is intended to cover modifications within the spirit and scope of the present invention as defined by the claims.

What is claimed is:

1. A canister for receiving a pressurized gas comprising:
a lateral wall defining an internal cavity;
an open top end formed by the lateral wall and in fluid communication with the internal cavity; and
a pierceable wall integrally formed with the lateral wall distal to the open top end, wherein the pierceable wall is a low puncture force pierceable wall.

2. The canister of claim 1, wherein the low puncture force pierceable wall is pierceable by a low puncture force less than 10 lb_{f}, or less than about 2 lb_{f}, or less than about 1 lb_{f}.

3. The canister of claim 1, wherein the pierceable wall is configured to be pierceable due to shear failure.

4. The canister of claim 1, wherein the low puncture force pierceable wall is pierceable by a low puncture force less than about 2 lb_{f} due to shear failure.

5. The canister of claim 1, wherein the pierceable wall has a wall thickness less than about 0.40 mm, or less than about 0.10 mm.

6. The canister of claim 1, wherein the pierceable wall has a shear strength suitable to be pierceable by a puncture force less than 10 lb_{f}, or less than about 2 lb_{f}.

7. The canister of claim 1, wherein the pierceable wall has a shear strength suitable to be pierceable by an awl tool with a puncture force less than 10 lb_{f}, or less than about 2 lb_{f}.

8. The canister of claim 1, wherein the pierceable wall is sized and configured to withstand a load no greater than 10 lb_{f}, or no greater than about 2 lb_{f}.

9. The canister of claim 1, wherein the pierceable wall is sized and configured to store pressures no greater than about 1300 psi, or no greater than about 900 psi.

10. The canister of claim 1, wherein the pierceable wall extends substantially transverse to the lateral wall, or wherein the pierceable wall comprises at least one of aluminum, steel, tin, gold, silver, and nickel.

11. The canister of claim 1, further comprising a sealing member for hermetically sealing the open top end.

12. The canister of claim 1, wherein the lateral wall includes a main body portion and a nose portion having an overall width less than the main body portion.

13. The canister of claim 12, wherein the pierceable wall is integrally formed with the nose portion, or wherein the nose portion has an overall width less than about 3 mm.

14. The canister of claim 1, wherein the lateral wall has an overall longitudinal length of less than about 20 mm and an overall width of less than about 10 mm, or wherein the lateral wall is substantially cylindrical in shape.

15. The canister of claim 1, wherein the internal cavity has a volume of about 0.125 cm³ to about 1.25 cm³.

16. A system for delivering a flow of pressurized gas comprising:
the canister of claim 1; and
a piercing member movable between a first position spaced from the canister and a second position piercing the pierceable wall of the canister.

17. The system of claim 16, wherein the piercing member includes a piercing device comprising a pointed stake, or wherein the piercing member includes a piercing device comprising a pointed stake having a pointed tip at angle of about 30-60 degrees, or wherein the piercing member is sized and configured to pierce the pierceable wall upon engagement thereto and application of a low puncture force less than 10 lb_{f}, or wherein the piercing member comprises a piercing device having a hardness greater than a hardness of the pierceable wall, or wherein the piercing member comprises a piercing device having a diameter of about 0.75 mm, or wherein the piercing member comprises a piercing device in the form of an annular needle, an annular stake, an annular wedge having an aperture extending therethrough, or a flat spike.

18. The system of claim 16, wherein the pierceable wall comprises a Rockwell Hardness of 20B-60B and the piercing device comprises a Rockwell Hardness of 65B-100B.

19. The system of claim 16, further comprising an actuator to urge the piercing member from the first position to the second position.

20. A method of manufacturing a pressurized gas canister comprising:
forming the canister of claim 1 as a unitary part;
filling the canister with a gas at a pressure of at least 15 psi through the open top end; and
hermetically sealing the canister with a sealing member after filling the canister.

21. The method of claim 20, wherein the forming step comprises machining, cold forming, drawing and/or punching.

22. A pressurized gas canister comprising:
a lateral wall defining an internal cavity;
an open top end formed by the lateral wall and in fluid communication with the internal cavity;
a low puncture force pierceable wall hermetically sealed with the lateral wall distal to the open top end, wherein the low puncture force pierceable wall is pierceable by a low puncture force less than 10 lb_{f};
a gas within the internal cavity at a pressure of at least 15 psi; and
a sealing member hermetically sealing the open top end by press-fit and/or mechanical engagement.
